(19) United States
(12) Patent Application Publication
(10) Pub. No.: US 2024/0051030 A1
(43) Pub. Date: Feb. 15, 2024

(54) A vertically insulated, homogeneously heated melting system with a cooled opening for the inlet of a filament for 3D printers with a horizontally insulated, homogeneously heated melting system allowing the nozzle to be gripped for 3D printers

(71) Applicant: PROTOPRINT s.r.o., Plav (CZ)

(72) Inventors: Pavel Sedlacek, Pilsen (CZ); Stepan Janas, Plav (CZ)

(21) Appl. No.: 18/258,202

(22) PCT Filed: Dec. 17, 2020
(86) PCT No.: PCT/IB2021/061831

§ 371 Date: Jun. 16, 2023

(30) Foreign Application Priority Data
Dec. 17, 2020 (CZ) PV 2020-689

(51) Int. Cl. B22F 12/53; B33Y 30/00; B33Y 40/10; B22F 10/22

(52) U.S. Cl. CPC B22F 12/53; B33Y 30/00; B33Y 40/10; B22F 10/22

(57) ABSTRACT

The melting system with a cooled opening of the filament inlet for 3D printers, characterized in that it comprises the melting nozzle body, thermally connected with the heating system, fitted with the nozzle channel for the filament passage having the shape of a hollow body with a circular cross-section and with a constant or continuously variable diameter, where the nozzle channel is led by the filament feeder outside the melting nozzle body and terminated by the opening for the filament inlet; the filament feeder and the melting nozzle body are connected by a non-dismountable connection or are manufactured from one piece and the value of thermal transmittance of the filament feeder is at least 3 times lower than the value of thermal transmittance of the melting nozzle body.

### FIELD OF THE TECHNOLOGY

3D printing and 3D printers

### STATE OF THE ART

3D printing has long ceased to be a privilege of big corporations and laboratories. With the technology development, the availability of 3D printers improved and they finally found their way to common households. Emphasize is placed on the variability of parts, their easy maintenance and replacement, which also reduces the acquisition and operating costs of a 3D printer as it is no longer necessary to replace the entire assemblies of the printer but only individual component. Printing has become more complex and sophisticated and the high precision of print jobs required. However, the current print heads, so-called “hot ends” suffer from substantial shortcomings, such as in particular the melted filament escaping from below in the connection between the guide tube and the melting nozzle and the high value of the guide tube heat conductivity that causes early softening of the filament and considerably impairs the precision of printing. Both escaping from below and softening of the filament result in inaccurate settings of the beginning of printing, errors in the course of printing, and defective prints in general. This fact limits 3D printers in deployment for printing products that require precision and in addition, introduces the printing error rate.

The design of 3D printers comprises a print head placed on guide rails, along which the print head moves in the x, y, and z axes in the pre-programmed directions depending on the shape of the required print. The printing filament is inserted into the print head where it passes through the guide tube and into the melting nozzle where the filament is melted and gradually discharged onto the print bed under the guide rails. Layers of the melted filament are gradually arranged onto the print bed, thus creating the required 3D print.

Filament escaping from below is caused by heat conduction within the print head and also by a dismountable connection of the filament guide tube to the melting nozzle. The print head is usually designed to allow an easy replacement of the melting nozzle due to the fact that the guide tube fits freely to the melting nozzle or is freely inserted into the melting nozzle. This means that the connection between the melting nozzle and the guide tube does not fit tightly. It is exactly this connection where the filament escaping from below occurs as the melting nozzle is heated intensely and the filament becomes melted at the guide tube/melting nozzle interface already.

The dismountable connection between the guide tube and the melting nozzle loosens due to the repeated heating and cooling of the components and also as a result of vibrations caused by the movement of the print head along the guide rails. The print head heating results in the loosening of the dismountable connection between the melting nozzle and the guide tube; the connection needs to be retightened at the temperature equal to that of printing. For this reason, standard melting nozzles are fitted with a hexagonal head allowing the melting nozzle to be retightened in the print head even during a print job.

Loosening the dismountable connection between the melting nozzle and the guide tube leads to the filament escaping from below, and/or the complete escape of the molten filament and destruction of not yet finished print, damage to the print head or even the 3D printer itself due to the fact that the discharged filament solidified and the unsupervised printer got seized.

The melting nozzle is usually heated by only one source of heat, most commonly an extruder core with a desirable value of heat-carrying capacity that is inserted in the material surrounding the melting nozzle of the print head. Such an arrangement has another drawback, namely uneven filament melting, and/or the melting nozzle overheating resulting from the need of temperatures sufficient for the filament melting even in the coolest portion of the melting nozzle that is furthermost from the source of heat. With the only source of heat, the material, in which the source of heat is inserted, must be very efficient in terms of heat carrying. The whole melting nozzle is then heated to a relatively high temperature, approx. 190 to 280° C., depending on the filament material employed. Naturally, the melting nozzle heated up to such a high temperature and being made of metal, heats up the print head as well. Some newer print heads are fitted with a cooler through which the guide tube passes before it comes into contact with the melting nozzle. The purpose of the cooler is to cool down the guide tube that is indirectly heated via the nozzle and prevent the filament from melting before its entry into the melting nozzle. Regardless of the fact that filament escaping from below is eliminated to a certain extent thanks to the cooler, it is not eliminated completely. In particular in the case of a longer print job when the melting nozzle is intensely heated, escaping from below occurs anyway.

The state of the art, where the guide tube is fitted on the melting nozzle in a dismountable manner only, is available from for example Prusa Research a.s., FIG. 1A. The manufacturer provides two types of the guide tube connection to the melting nozzle, namely: all-metal embodiment where the melting nozzle fits close to the guide tube, surface-to-surface, and the connection is fixed by thread retightening. The other embodiment is hybrid; in this case the guide tube is made of PTFE Teflon and fits close directly on the proximal end of the melting nozzle. The guide tube can easily be replaced by its pulling out from the upper portion of the cooler without the necessity to dismantle the nozzle. The guide tube has no thread or any attachment mechanism. After the print head is assembled, the guide tube fits freely on the upper end of the melting nozzle. Both embodiments have the aforementioned drawbacks that lead to imprecise print, damaged print or even damage to the 3D printer.

Another manufacturer of print heads for 3D printers representing the general state of the art is for example Slice Engineering with its print head The Mosquito Hotend, FIG. 1B. The print head The Mosquito Hotend is disclosed in the patent application WO2018/213559A1. For example, in FIG. 9 of this document, it can be seen that the guide tube 104 is terminated by its end opening 111 at the interface with the melting nozzle 103. In addition, the guide tube 104 is made of metal (paragraph [0056]), which results in its bottom portion 112 heating. As it ensues from FIG. 9, the filament 110 melts in this bottom portion 112 of the guide tube 104 already, which leads to the molten filament 110 escaping from below at the connection of the guide tube 104 and the melting nozzle 103. The design of the print head is also disclosed in claim 1 stating that the bottom portion 112 of the guide tube 104 is in contact with the heating element 102 to soften the material 115 of the filament 110 before its entering the melting nozzle 103. This solution cannot be used for precise prints on the grounds of the filament escaping from below.

Another document describing the state of the art is DE 102015012907 A1 covering in particular gradual melting of the filament and easy replacement of the feeder allowing a quick and easy conversion of the print head to accommodate different 3D printing materials, such as pastes, silicones, mineral compounds, polymers that can be cured by actinic or chemical reactions, i.e. in general materials that are in solid aggregate state at the beginning of transport. This document also accentuates an easy and quick conversion of the internal diameter of the feeder where one component is replaced by another one component, meaning that also printing filaments of a thicker, non-standard internal diameter can be used in no time.

The design of 3D printers comprises a print head placed on guide rails, along which the print head moves in the x, y, and z axes in the pre-programmed directions depending on the shape of the required print. The printing filament is inserted into the print head where it passes through the guide tube and into the melting nozzle where the filament is melted and gradually discharged onto the print bed under the guide rails. Layers of the melted filament are gradually arranged onto the print bed, thus creating the required 3D print.

The melting nozzle is usually heated by only one source of heat, most commonly an extruder core or a little rod with desirable heat-carrying capacity that is inserted in the material surrounding the melting nozzle of the print head. Such an arrangement has a serious drawback, namely uneven filament melting, and/or the melting nozzle overheating resulting from the need of temperatures sufficient for the filament melting even in the coolest portion of the melting nozzle that is furthermost from the source of heat. With the only source of heat, the material, in which the source of heat is inserted, must be very efficient in terms of heat carrying. The whole melting nozzle is then heated to a relatively high temperature, approx. 190 to 280° C., depending on the filament material employed. The need for some material with a high value of heat-carrying capacity between the heating extruder core and the melting nozzle leads to the fact that with the state-of-the-art print heads their entire bottom portion is hot, so-called “hot-ends”. During a print job, this bottom portion of the print head reaches a temperature ranging from approximately 200 to 300° C.

A print job must also enable fast printing and a possibility of a quick response in the case of a defective print allowing the correct print job to be recovered as soon as possible without any unnecessary downtime. The essential parameter in such a case is the print head handling immediately after the print job is completed. It may happen that a print job is corrupted in its course, for example because of the filament escape from below or because of insufficient homogeneous heating of the filament in the melting nozzle. Immediately after the print job completion thus it is not possible to handle with the print head and you must wait until the print head, or its “hot end”, respectively cools down. If a print job is defective, not only the time of the print job itself is lost, but also the time needed for the print head cooling down to allow, for example, the heating extruder core or the melting nozzle to be replaced, or the nozzle channel blocked by erroneously molten filament to be cleaned.

The state of the art where the entire bottom portion of the print head is heated up and as such cannot be handled is available from for example Prusa Research a.s., FIG. 9A. The “hot end” is made of exposed metal arranged in contact with the heating block, meaning that the entire “hot end” of the print head is heated. Another manufacturer of print heads for 3D printers representing the general state of the art is for example Slice Engineering with its print head The Mosquito Hotend, FIG. 9B. The print head The Mosquito Hotend is disclosed in the patent application WO2018/213559A1. For example, it ensues from FIG. 1, 3, 10, 11 or 12 of this document that the bottom portion of the nozzle head has the opening 120 for the insertion of a “heating element”, meaning a heating extruder core. The entire bottom portion of the print head 102, the “heater” is made of some heat-carrying material, as disclosed in the application in paragraph [0057] and substantiated by the website presentation of Slice Engineering, from which it is obvious that the bottom portion of the print head is made of metal.

Therefore the print heads according to the state of the art are not able to provide the print nozzle handling during or immediately after a print job, which means that they impede maintenance or replacement of the print head components. Moreover, the standard, unilateral method of the melting nozzle heating causes uneven melting of the filament, which results in defective prints.

### DESCRIPTION OF THE INVENTION

A special melting system has been developed that is insulated in both horizontal and vertical directions, which results in multiple advantages: no heat losses from the heated zone, thus improving the efficiency of the filament heating and melting, and the print head can be handled immediately after a print job completion as it is not hot in gripping places. Thanks to the thermal insulation and the fixed connection between the melting nozzle and the filament feeder, molten filament escaping from below has been eliminated. In addition, the heating element of the melting system has the shape of a ring or collar and is fitted onto the melting nozzle, thus allowing not only efficient but also especially homogeneous heating of the melting nozzle along its entire perimeter to be achieved along with the homogeneous melting of the printing filament.

The entire invention comprises two main components:
The vertically insulated, homogeneously heated melting system—insulation of heat moving upwards along the filament feeder, i.e. in the vertical direction
The horizontally insulated, homogeneously heated melting system—insulation of heat during the nozzle gripping, i.e. in the horizontal direction
and these two systems are connected by the system of homogeneous heating in the form of a fitted ring.

The vertically insulated, homogeneously heated melting system with a cooled opening for the filament inlet intended for 3D printer print heads eliminates the filament escaping from below, discharge and early softening due to the fact that the first opening leading from the melting zone of the print head is situated in the cooler, meaning that it is actively cooled, and the filament in its space is maintained under its softening, not to say melting, temperature. The aforementioned advantages result from a non-dismountable connection between the nozzle channel and the filament feeder on whose distal end the opening is situated. The opening cooling is intensified by different heat-carrying capacities of the three essential components, namely the melting nozzle, made of some material with a high value of heat-carrying capacity—a heat conductor, the filament feeder, made of some material with a low value of heat-carrying capacity—a heat non-conductor, and the cooler that is made again of some material with a high value of heat-carrying capacity—a heat conductor. This unique system heat conductor—heat non-conductor—heat conductor (CNC) provides for the thermal insulation of the heated zone in the vertical direction where the heat required for the filament melting remains within the melting nozzle having a high value of heat-carrying capacity and is not actively removed by the filament feeder as the filament feeder is a heat non-conductor. A small amount of heat is conducted to the filament feeder by the molten filament, which is however immediately cooled down due to heat removal by the cooler that is a heat conductor. There are thermal bridges between the essential components with a retaining thermal bridge between the melting nozzle and the filament feeder insulating the nozzle from the remaining portion of the print head in the vertical direction, thus allowing heat to be retained in the melting nozzle. The thermal bridge between the filament feeder and the cooler is of the removing type as it actively removes heat from the filament feeder via the cooler. Thanks to this cooling, the temperature in the place of the opening for the filament inlet is far below the filament melting temperature.

The melting system comprises the melting nozzle body onto which the heating system, thermally connected with the melting nozzle, is fitted. The melting nozzle body is equipped with a nozzle channel allowing the filament passage. The nozzle body is connected to the filament feeder by a non-dismountable connection; the filament feeder leads the nozzle channel outside the nozzle body and into the cooling zone, and is terminated by an opening for the filament inlet. By this opening, the melting system is interconnected with the other components of the print head, in particular with the filament guide tube. This connection may be of a dismountable type as the temperature in the place of the opening for the filament inlet is already lower than the melting temperature of the filament. At the same time, the length of the filament feeder is such to allow the opening for the filament inlet to be situated within the cooler. A too long filament feeder causes undesirable waving and seizing of the filament being fed. In the most preferred embodiment, the active contact length of the filament feeder, meaning the length of its embedding in the cooler, ranges from 20 to 80 mm.

In addition, a special horizontally insulated, homogeneously heated melting system has been developed, that allows the 3D printer nozzle to be gripped and that insulates the melting nozzle in the horizontal direction and also offers some user comfort and a possibility of immediate print head handling during a print job. The system completely eliminates the major drawback resting in impossibility to handle the hot bottom end of the print head where, for example, in the case of filament escape from below, blocked nozzle, or filament seizure, it is not possible to dismantle the melting nozzle immediately and the operator must wait, until the nozzle cools down. In addition, the melting system eliminates the uneven heating of the melting nozzle and maximizes the heating process efficiency as only the portion of the nozzle channel where filament melting is required is heated without having to heat the entire print head from the outside as well. The required necessary heat output of the system is therefore much lower. The melting system is fitted with a heating element in the shape of a ring that encompasses the melting nozzle thus providing homogeneous heating. In addition, the melting system is fitted with at least one insulation layer separating the heating element from the environment, which prevents the entire bottom portion of the print head from being heated and therefore allows easy print head handling during a print job and after its completion as well.

Horizontally Insulated, Homogeneously Heated Melting System

Vertically Insulated, Homogeneously Heated Melting System

The combination of the vertically insulated, homogeneously heated melting system with

a cooled opening for the filament inlet with the horizontally insulated, homogeneously heated melting system leads to a dream print head. Such a print head differs from the state of the art fundamentally thanks to its fixed connection between the melting nozzle and the filament feeder preventing molten filament from escaping from below, the melting nozzle easily replaceable together with the filament feeder, and also due to the fact that the print head can be handled during a print job or immediately after its completion or termination thanks to the thermally insulated melting system. The thermally insulated melting system in the shape of a ring or collar fitted on the melting nozzle also makes it possible to heat the melting nozzle in a homogeneous and controlled manner within its entire cross section without any uneven melting or seizing of the filament.

The melting system completely eliminates the filament escape from below outside the nozzle opening, thus eliminating possible damage to a print job, the print head, or the 3D printer as a whole. In addition, the melting system allows easy replacement of the melting nozzle together with the filament feeder without having to wait until the nozzle cools down as all molten filament remains in the closed melting system during replacement.

Compared to the state of the art, the dismountable connection—the connection of the opening for the filament inlet and the other print head components, where the molten filament could escape from below, is situated outside the nozzle body, in the cooling zone, meaning outside the heated region. The filament retains its solid state in the place of the dismountable connection, its softening does not occur here and it is melted as far as in the melting zone of the melting nozzle that is closed in a non-dismountable manner.

Another parameter of the melting system is a different thermal transmittance coefficient of the material of the nozzle and that of the filament feeder where the thermal transmittance coefficient of the filament feeder material is at least 3 times lower than the thermal transmittance coefficient of the melting nozzle body material. In a preferred embodiment, it is 7 times lower. The desired arrangement is attained either by the fact that although the filament feeder and the melting nozzle body are made of the same material, the wall thickness of the filament feeder is at least 3 times lower than the thickness of the wall of the melting nozzle body, and/or the filament feeder is made of some material whose thermal conductivity coefficient is lower at least by 30 W/mK than that of the material of which the melting nozzle body is made. Thanks to the lower value of thermal transmittance and/or conductivity, the filament feeder acts as a thermal brake slowing down the conduction of heat to the opening for the filament inlet, or to the dismountable connection of the opening with the remaining components of the print head, respectively. The filament inlet is thus passively cooled down by the filament feeder having the properties of a thermal brake. In a preferred embodiment the filament feeder is equipped with a cooler, meaning that the connection of the opening for the filament inlet together with other components of the print head are placed in an actively cooled area, which further increases the effect of the filament feeder thermal brake.

The melting system according to the present invention is designed for the print heads for 3D printing. The melting system includes the melting nozzle and the filament feeder, which are connected in a permanent and non-dismountable manner. In a preferred embodiment, the melting nozzle is made of: copper, aluminium, bronze, brass, iron, steel, silver, gold, diamond, tungsten, tungsten carbide (TC), silicon carbide (SiC, SiSiC), aluminium oxide (Al₂O₃) or mixtures thereof. In a preferred embodiment, the nozzle is surface-treated, for example, by nickel or diamond like carbon (DLC).

In a preferred embodiment, the filament feeder is made of: copper, aluminium, bronze, brass, iron, steel, silver, gold, diamond, tungsten, tungsten carbide (TC), silicon carbide (SiC, SiSiC), aluminium oxide (Al₂O₃), magnesium oxide (MgO), ytterbium oxide (Y₂O₃), zirconium dioxide (ZrO₂), machinable vitroceramics, stealite, ceramics, polytetrafluorethylene (PTFE), polyaryletherketone (PAEK), polyether ether ketone (PEEK), polyetherimide (PEI) or a mixture thereof, provided that the following condition is fulfilled: the thermal transmittance coefficient of the filament feeder must be at least 3 times lower than that of the melting nozzle.

The melting nozzle is thermally connected to the heating system, i.e. a heating ring or collar fitted on the melting nozzle. The zone that is in direct connection with the heating system is referred to as melting—the melting nozzle has the highest temperature here. Next to the melting zone is the heated zone where the melting nozzle temperature is lower than that in the melting zone. The print head, in which the melting system is positioned, is equipped with the cooling zone as well. In a preferred embodiment, the cooling zone refers to the cooler zone. The connection between the opening for the filament inlet and the other components of the print head is positioned exactly in this cooling zone, by which the risk of escape from below is completely eliminated. Considering the fact that the nozzles are usually made of the materials with high values of thermal conductivity, preferably exceeding 200 W/mK, the entire body of the nozzle is the heated zone. The border of the melting nozzle body is also the end of the heated zone and a place where the non-heated zone begins.

The purpose of this invention is to extend the nozzle channel as far as into the cooling zone, to the area outside the melting nozzle, meaning to bring out the opening for the filament inlet up to the place where the risk of filament early melting and its escaping from below through any of the connections is minimized.

In a preferred embodiment, the melting nozzle in its cylindrical portion is fitted with an external thread corresponding with the internal thread of the heating element or the print head, respectively for easy attachment in the print head.

The vertically insulated, homogeneously heated melting system

with a cooled opening for the filament inlet is equipped with an insulated heating system. The insulated heating system for the melting system with the cooled opening for the filament inlet is designed in a manner allowing heat from the heating element to be transferred onto the melting nozzle. The heating element in the shape of a ring or collar is fitted onto the melting nozzle or its casing, respectively and thermally connected therewith, by which the melting nozzle is heated up to the melting temperature. This thermal connection is implemented either by direct contact between the heating element and the melting nozzle, where the heating element encloses the nozzle similarly as a ring encloses the finger, or in a preferred embodiment, the thermal connection is implemented by an interlayer comprised of another component—a heating insert. In a preferred embodiment, the heating insert has the shape of a collar or tube and its purpose is to provide high-quality heat distribution from the heating element to heat up the melting nozzle enclosed by the heating insert.

This means that it has a close contact with the melting nozzle on one end and with the heating element on the other end.

The melting system is insulated from its surroundings, namely by an air pocket and an insulation shell. The insulation shell is fitted on the heating element; the insulation shell is hollow and comprises free insulation space, i.e. air pocket, between its inner casing and the outer casing of the heating element. The insulation shell together with the air pocket isolate heat required for the melting nozzle heating up from the environment, thus not only reducing thermal losses of the heating system, but also making handling with the entire print head easier during a print job and immediately thereafter.

For the melting system according to the present invention, it is possible to use the standard melting nozzle, preferably of the shape of a cylinder with a polygonal head, at least trigonal and hexagonal in a preferred embodiment. The shaping of the heating system depends on the employed melting nozzle or its shape, respectively as it is important to create a thermal connection between the melting nozzle and the heating system, ideally by direct or indirect contact. Insulation material shaping does not depend on the nozzle, however, in a preferred embodiment, openings in the insulation shell correspond with the shape of the nozzle to maintain the entire system cohesion. In such a case it is also ensured that there are no heat losses from the inner space of the system and that the system is efficiently insulated from the surrounding environment. In another preferred embodiment the insulation shell lacks one or both bases and is attached to the nozzle for example by a perforated pad. In such a case the insulation shell is used in particular for gripping the print head and the space between the insulation shell and the heating element is ventilated by the perforated pad where the perforations are utilized for a reduction of the entire hot end weight.

The melting nozzle is made of some material that conducts heat well, meaning that its thermal conductivity coefficient is preferably at least 30 W/mK. In a preferred embodiment, the melting nozzle is made of copper, aluminium, bronze, brass, carbide, such as TC or SiC, of ceramics with a desirable value of thermal conductivity, such as that with the content of Al₂O₃, or a mixture thereof. In a preferred embodiment, the nozzle is surface-treated, for example, by nickel or diamond like carbon (DLC). In a preferred embodiment, the melting nozzle in its cylindrical portion is fitted with an outer thread corresponding with the inner thread of the mating components, in particular of the heating insert, and/or other components of the print head.

The heating element has the shape of a hollow body with a circular cross-section and with either a constant or continually variable diameter, meaning a hollow cylinder with no bases or a converging/diverging tube, and in the system, it provides for heating the melting nozzle that is cylindrical. Thanks to its circular shape, the cylindrical melting nozzle is enclosed, thus creating a thermal connection or directly a thermal contact of the heating element and the melting nozzle casing and providing its homogeneous heating. The heating element is made of some material with the value of thermal conductivity coefficient at least 20 W/mK, preferably at least 50 W/mK. In a preferred embodiment, the heating element is made of copper, aluminium, bronze, brass, silver, gold or alloys thereof, in addition of carbide, such as TC or SiC, of ceramics with a desirable value of thermal conductivity, such as that with the content of Al₂O₃, or a mixture thereof.

If the source of heat of the heating element is electric resistance, some electric insulation material needs to be placed between the source of heat and the other components of the system. In a preferred embodiment, the source of heat is a resistance wire or a blade in the shape of a collar or a spiral inserted into the heating element referring to a ceramic collar. In another embodiment, the heating element is the resistance wire or blade itself, however, some electric insulation material, such as in the form of a heat-resistant film, tape, paste, or adhesive, must be present between the heating element and the other components of the system, i.e. the melting nozzle or heating insert.

Another source of heat for the heating element may be, for example, medium in a closed system, in particular oil medium in a tube made of a heat-conducting metal.

In a preferred embodiment, the heating insert is present in the system. It is placed between the heating element and the melting nozzle casing and its purpose is to distribute heat from the heating element along the entire length of the melting nozzle. The heating insert is made of the material that conducts heat well, meaning that its thermal conductivity coefficient is preferably at least 20 W/mK, more preferably at least 150 W/mK. In a preferred embodiment, the heating insert is made of copper, aluminium, bronze, brass, carbide, such as TC or SiC, of ceramics with a desirable value of thermal conductivity, such as that with the content of Al₂O₃, or a mixture thereof.

To attain even more effective heat conduction, in a preferred embodiment thermally conductive paste is applied in the interfaces of individual components. It is preferably placed between the heating element and the melting nozzle casing, and/or between the heating element and the heating insert, and/or between the heating insert and the melting nozzle casing.

The insulation shell has the opposite function, namely thermal insulation and deceleration of heat conduction in the system. The insulation shell is made of the material with the value of thermal conductivity coefficient not exceeding 50 W/mK, preferably not exceeding 15 W/mK. In a preferred embodiment, the insulation shell is made of zirconium ceramics, aluminium ceramics (Al₂O₃), of stainless steel, titanium, glass, zirconium dioxide (ZrO₂), machinable vitroceramics, stealite, ceramics, polytetrafluorethylene (PTFE), polyaryletherketone (PAEK), polyether ether ketone (PEEK), polyetherimide (PEI) or a mixture thereof. The insulation shell is hollow and is equipped with at least two openings on the opposite sides. In a preferred embodiment, the insulation shell has the shape of a hollow cylinder or a hollow n-sided prism with a central opening in each of their bases, the diameter of which is greater than the smallest outer diameter of the melting nozzle; alternatively, the insulation shell has the shape of a hollow block, a hollow cube or a hollow polyhedron where the insulation shell is equipped with one opening in one of its sides and with the other opening in the opposite side and the diameters of the openings are greater than the smallest outer diameter of the melting nozzle.

In addition, the system is preferably fitted with a pad separating the heating portion of the system from the surrounding environment and holding all components of the system in their places. The pad is preferably positioned above the head of the melting nozzle and is either an independent component, or part of the heating insert, heating element or insulation shell.

### SUMMARY

The vertically insulated, homogeneously heated melting system with a cooled opening (2.1) for the filament inlet for 3D printers, characterized in that it comprises the melting zone (100), heated zone (101), and cooled zone (102), where the heated zone (101) is mechanically connected with the cooled zone (102) and thermally insulated by the heat conductor-heat non-conductor-heat conductor (CNC) system, where the one heat conductor of the CNC system, being the melting nozzle (0), is situated inside the heated zone (101) and the other heat conductor of the CNC system, being the cooler (3), is situated in the cooled zone (102), where both heat conductors are mechanically connected by the heat non-conductor, being the feeder (2) of the filament, which is also thermally connected to both the melting nozzle (0), and the cooler (3); the melting zone (100) is equipped with the heating element (204) connected to a source of heat, where the source of heat is comprised of a hollow body comprising a cavity with a circular cross-section that is fitted onto the body (1) of the melting nozzle (0) and is thermally connected to the body (1) of the melting nozzle (0), where the melting nozzle (0) is equipped with the nozzle channel (1.2) for the passage of the filament having the shape of a hollow body with a circular cross-section and with a constant or continuously variable diameter, where the nozzle channel (1.2) is led by the feeder (2) of the filament outside the body (1) of the melting nozzle (0) and terminated by the opening (2.1) for the filament inlet, situated in the cooler (3), meaning in the cooled zone (102), the feeder (2) of the filament and the body (1) of the melting nozzle (0) are connected by a non-dismountable connection or are manufactured from one piece, the feeder (2) of the filament is implanted in the cooler (3) up to a depth of at least 4 mm, and the cooler (3) is offset from the melting nozzle (0) by at least 1 mm, and the value of thermal transmittance of the body (2) of the filament is at least 3 times lower than the value of thermal transmittance of the body (1) of the melting nozzle (0) and the value of thermal transmittance of the feeder (2) of the filament is at least 3 times lower than the value of thermal transmittance of the cooler (3).

The vertically insulated, homogeneously heated melting system with a cooled opening for the filament inlet for 3D printers comprises the melting nozzle body, thermally connected with the heating system, fitted with the nozzle channel for the passage of the filament having the shape of a hollow body with a circular cross-section and with a constant or continuously variable diameter, where the nozzle channel is led by the filament feeder outside the melting nozzle body and terminated by the opening for the filament inlet; the filament feeder and the melting nozzle body are connected by a non-dismountable connection or are manufactured from one piece and the value of thermal transmittance of the filament feeder is at least 3 times lower than the value of thermal transmittance of the melting nozzle body.

In a preferred embodiment, the length of the filament feeder above the melting nozzle body or the shortest distance of the opening for the filament inlet from the melting nozzle body, respectively, ranges from 20 to 80 mm.

In a preferred embodiment, the heating system is fitted onto the melting nozzle body and comprises a resistance wire connected to a source of electric current.

In a preferred embodiment, the melting nozzle body is made of material whose thermal conductivity is at least 30 W/mK.

In a preferred embodiment, the melting nozzle body is made of: copper, aluminium, bronze, brass, iron, steel, silver, gold, diamond, tungsten, tungsten carbide (TC), silicon carbide (SiC, SiSiC), aluminium oxide (Al₂O₃) or a mixture thereof.

In a preferred embodiment, the filament feeder is made of copper, aluminium, bronze, brass, iron, steel, silver, gold, diamond, tungsten, tungsten carbide (TC), silicon carbide (SiC, SiSiC), aluminium oxide (Al₂O₃), magnesium oxide (MgO), ytterbium oxide (Y₂O₃), zirconium dioxide (ZrO₂), machinable vitroceramics, stealite, ceramics, polytetrafluorethylene (PTFE), polyaryletherketone (PAEK), polyether ether ketone (PEEK), polyetherimide (PEI) or a mixture thereof.

In a preferred embodiment, the filament feeder has the value of thermal conductivity coefficient lower by at least 30 W/mK than that of the melting nozzle body.

In a preferred embodiment, the filament feeder has the thickness of the wall at least 3 times smaller than the melting nozzle body.

In a preferred embodiment, the filament feeder has the thickness of the wall at least 7 times smaller than the melting nozzle body.

In a preferred embodiment, the non-dismountable connection between the filament feeder and the melting nozzle body is created by brazing, soldering, gluing, pressing or etching.

In a preferred embodiment, the filament feeder and the melting nozzle body are turned out from one piece of material.

In a preferred embodiment, the filament feeder and the melting nozzle body are turned out from one solid piece manufactured from two materials with a material gradient between them.

In a preferred embodiment, the melting nozzle body is fitted with a sleeve flange in the place of the nozzle channel outlet at the end opposite to the nozzle opening, onto which the filament feeder is fitted.

In a preferred embodiment, the filament feeder is attached to the melting nozzle body in the place of the nozzle channel outlet at the end opposite to the nozzle opening, or it is inserted into the nozzle channel.

In a preferred embodiment, the filament feeder is equipped with an outer thread.

In a preferred embodiment, the outer thread on the filament feeder corresponds with the inner thread of the cooler.

The horizontally insulated, homogeneously heated melting system for gripping the nozzle for 3D printers, characterized in that it comprises the melting nozzle (0), the heating element (204) connected to the source of heat formed by a hollow body with a cavity having a circular cross-section that is fitted onto the body (1) of the melting nozzle (0) and is thermally connected to the body (1) of the melting nozzle (0) by fitting onto, and the heating element (204) is fitted with the insulation shell (202), where the melting nozzle (0) has the shape of a cylinder with a through channel, where between the outer casing (204.1) of the heating element (204) and the inner casing (203) of the insulation shell (202), perpendicularly to the axis (1.4) of the melting nozzle (0), is free insulation space (206).

The insulated, homogeneously heated melting system for 3D printers comprises the melting nozzle with the fitted heating element where the heating element is fitted with the insulation shell where the melting nozzle has the shape of a cylinder with a through channel; the heating element is comprised of at least a hollow body having a circular cross-section with a constant or continuously variable diameter, has the value of thermal conductivity at least 20 W/mK and is thermally connected to the melting nozzle casing and is also connected to a source of heat, where between the outer casing of the heating element and the inner casing of the insulation shell, perpendicularly to the axis of the melting nozzle, is free insulation space.

In a preferred embodiment, the heating element has the shape of a hollow cylinder with no bases.

In a preferred embodiment, the insulation shell has the shape of a hollow cylinder, hollow n-sided prism, hollow cube or a hollow polyhedron, where the two opposite bases are equipped with central openings whose diameters are greater than the smallest outer diameter of the melting nozzle, or the insulation shell has the shape where the diameters of the openings are greater than the smallest outer diameter of the melting nozzle.

In a preferred embodiment, the heating insert comprised of at least a hollow cylinder is inserted between the heating element and the outer casing of the melting nozzle; the heating insert is in thermal contact with both the outer casing of the melting nozzle, and with the heating element.

In a preferred embodiment, the heating element is made of thermally conductive ceramics with the content of Al₂O₃, SiC, SiO₂, tungsten carbide WCor a mixture thereof.

In a preferred embodiment, the heating insert is made of material whose thermal conductivity is at least 20 W/mK.

In a preferred embodiment, the heating insert is made of aluminium, copper, bronze, brass, silver, gold, carbide, ceramics or a mixture thereof.

In a preferred embodiment, thermally conductive paste is applied between the heating element and the melting nozzle casing, and/or between the heating element and the heating insert, and/or between the heating insert and the melting nozzle casing.

In a preferred embodiment, the insulation shell is made of material whose thermal conductivity does not exceed 50 W/mK.

In a preferred embodiment, the insulation shell is made of ceramics, preferably zirconium ceramics, aluminium ceramics (Al₂O₃), of stainless steel, titanium, glass, zirconium dioxide (ZrO₂), machinable vitroceramics, stealite, ceramics, polytetrafluorethylene (PTFE), polyaryletherketone (PAEK), polyether ether ketone (PEEK), polyetherimide (PEI) or a mixture thereof.

In a preferred embodiment, the melting nozzle is fitted with a head, the diameter of which is greater than the diameter of the cylindrical portion of the melting nozzle.

In a preferred embodiment, the bottom edge of the heating element fits close to the flat circular pad with a central opening the diameter of which is greater than the smallest outer diameter of the melting nozzle and at the same time smaller than the greatest diameter of the melting nozzle.

In a preferred embodiment, the heating element and the pad are made of one piece.

In a preferred embodiment, the bottom edge of the heating insert fits close to the flat circular pad with a central opening the diameter of which is greater than the smallest outer diameter of the melting nozzle and at the same time smaller than the greatest diameter of the melting nozzle.

In a preferred embodiment, the heating insert and the pad are made of one piece.

In a preferred embodiment, the bottom edge of the insulation shell fits close to the flat circular pad with a central opening the diameter of which is greater than the smallest outer diameter of the melting nozzle and at the same time smaller than the greatest diameter of the melting nozzle.

In a preferred embodiment, the insulation shell and the pad are made of one piece.

### SUMMARY OF PRESENTED DRAWINGS

FIG. 1A State of the art, Průs̆a Research, the supply tube leads through the cooler as far as into the melting nozzle where it is freely connected, source: https://help.prusa3d.com/cs/guide/how-to-change-a-ptfe-tube-original-prusa-i3-mk3-mk2-5_17361/

FIG. 1B State of the art, Moskito

FIG. 2A Melting system with a cooled opening for the filament inlet for 3D printers, the melting nozzle with the welded-on filament feeder, sectional drawing.

FIG. 2B Melting system with a cooled opening for the filament inlet for 3D printers, the melting nozzle with the welded-on filament feeder, side view.

FIG. 2C Melting system with a cooled opening for the filament inlet for 3D printers, the melting nozzle with the welded-on filament feeder, bottom side view.

FIG. 3A Melting system with a cooled opening for the filament inlet for 3D printers, the melting nozzle with the filament feeder fitted on the sleeve flange, the same materials, sectional drawing.

FIG. 3B Melting system with a cooled opening for the filament inlet for 3D printers, the melting nozzle with the filament feeder fitted on the sleeve flange, the same materials, side view

FIG. 3C Melting system with a cooled opening for the filament inlet for 3D printers, the melting nozzle with the filament feeder fitted on the sleeve flange, the same materials, bottom side view

FIG. 4A Melting system with a cooled opening for the filament inlet for 3D printers, the melting nozzle with the filament feeder pressed in the melting nozzle, different materials, sectional drawing.

FIG. 4B Melting system with a cooled opening for the filament inlet for 3D printers, the melting nozzle with the filament feeder pressed in the melting nozzle, different materials, side view.

FIG. 5A Melting system with a cooled opening for the filament inlet for 3D printers, the melting nozzle with the inserted and pressed-in filament feeder, the same thickness, different materials, sectional drawing.

FIG. 5B Melting system with a cooled opening for the filament inlet for 3D printers, the melting nozzle with the inserted and pressed-in filament feeder, the same thickness, different materials, side view.

FIG. 5C Melting system with a cooled opening for the filament inlet for 3D printers, the melting nozzle with the inserted and pressed-in filament feeder, the same thickness, different materials, bottom side view.

FIG. 6A Melting system with a cooled opening for the filament inlet for 3D printers, the melting nozzle with the inserted and glued filament feeder, the same thickness, different materials, sectional drawing.

FIG. 6B Melting system with a cooled opening for the filament inlet for 3D printers, the melting nozzle with the inserted and glued filament feeder, the same thickness, different materials, side view.

FIG. 6C Melting system with a cooled opening for the filament inlet for 3D printers, the melting nozzle with the inserted and glued filament feeder, the same thickness, different materials, bottom side view.

FIG. 7A Melting system with a cooled opening for the filament inlet for 3D printers, the melting nozzle with the filament feeder fitted on the sleeve flange, etched, offset, the same thickness, different materials, sectional drawing.

FIG. 7B Melting system with a cooled opening for the filament inlet for 3D printers, the melting nozzle with the filament feeder fitted on the sleeve flange, etched, offset, the same thickness, different materials, side view.

FIG. 7C Melting system with a cooled opening for the filament inlet for 3D printers, the melting nozzle with the filament feeder fitted on the sleeve flange, etched, offset, the same thickness, different materials, bottom side view.

FIG. 8A Melting system with a cooled opening for the filament inlet for 3D printers, with the cooler fitted on the filament feeder, sectional drawing.

FIG. 8B Melting system with a cooled opening for the filament inlet for 3D printers, with the cooler fitted on the filament feeder, side view.

FIG. 8C Melting system with a cooled opening for the filament inlet for 3D printers, with the cooler fitted on the filament feeder, bottom side view.

FIG. 9A Melting system with a cooled opening for the filament inlet for 3D printers, with the heating system fitted on the melting nozzle

FIG. 9B Melting system with a cooled opening for the filament inlet for 3D printers, with the heating system fitted on the melting nozzle, with the designated melting, heated, and cooled zones

FIG. 10 Print head for 3D printers with the insulated heating system of the melting nozzle

FIG. 11 Insulated heating system of the melting nozzle for 3D printers, detail, according to Example 1

FIG. 12 Insulated heating system of the melting nozzle for 3D printers, detail, the pad separately, the heating insert, the insulation shell not included

FIG. 13 Insulated heating system of the melting nozzle for 3D printers, detail, the pad partially separately, the heating insert, the insulation shell not included

FIG. 14A Insulated heating system of the melting nozzle for 3D printers, detail, the pad implanted in the heating element, no heating insert, the insulation shell not included

FIG. 14B Insulated heating system of the melting nozzle for 3D printers according to FIG. 5A in cross-sectional view, including the insulation shell

FIG. 15A Insulated heating system of the melting nozzle for 3D printers, detail, the pad part of the heating insert, the insulation shell not included

FIG. 15B Insulated heating system of the melting nozzle for 3D printers according to FIG. 6A in cross-sectional view, including the insulation shell

FIG. 16 Insulated heating system of the melting nozzle for 3D printers, detail, the pad part of the insulation shell

FIG. 17A Thermal profile of the print head and the insulated heating system of the melting nozzle according to the present invention

FIG. 17B Thermal profile of the print head and the insulated heating system of the melting nozzle according to the present invention, comparison of time 0 and time 4 m 25 s

FIG. 18A Melting system with a cooled opening for the filament inlet for 3D printers with insulated, homogeneously heated melting system for 3D printers

FIG. 18B Melting system with a cooled opening for the filament inlet for 3D printers, with insulated, homogeneously heated melting system for 3D printers, detail

FIG. 19 Melting system with a cooled opening for the filament inlet for 3D printers with insulated, homogeneously heated melting system for 3D printers, the insulation shell not included

FIG. 20A State of the art, Průs̆a Research print head with an inserted extruder core, to heat up the melting nozzle, the entire bottom portion of the print head must be heated

FIG. 20B State of the art, Moskito print head, Slice Engineering, to heat up the melting nozzle, the entire bottom portion of the print head must be heated

FIG. 21 Diagram of the CNC system

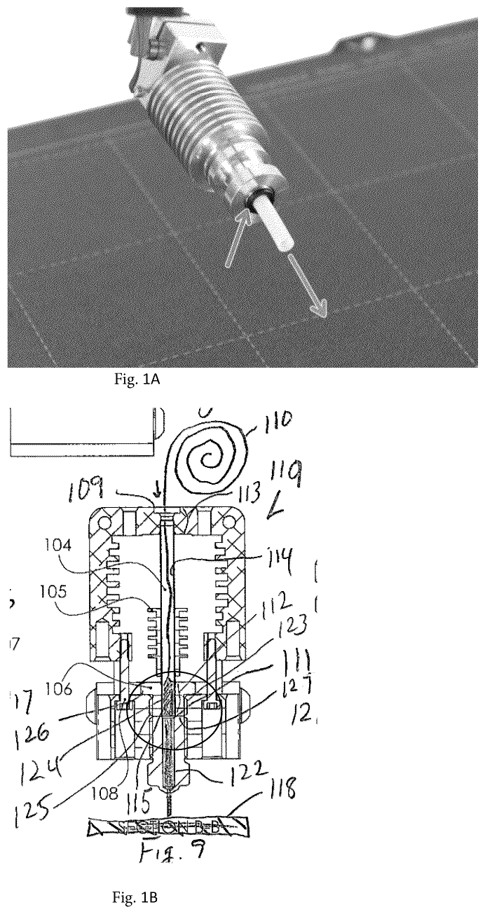

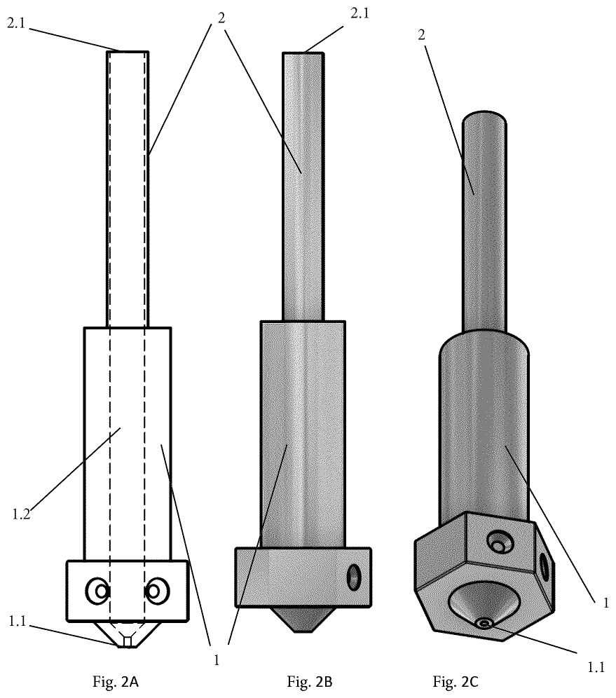

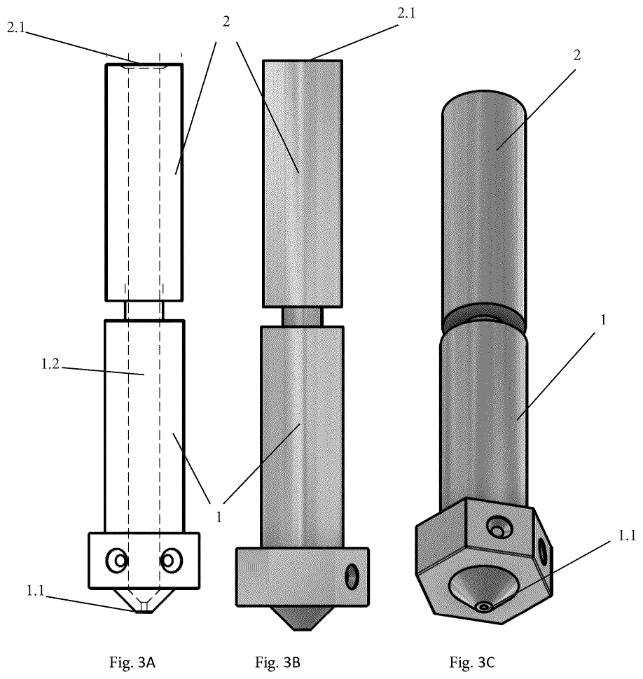

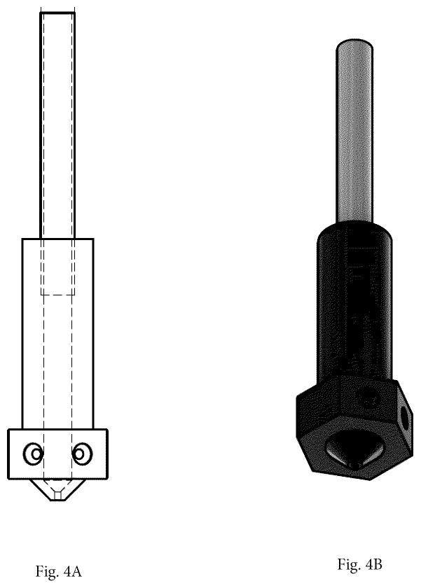

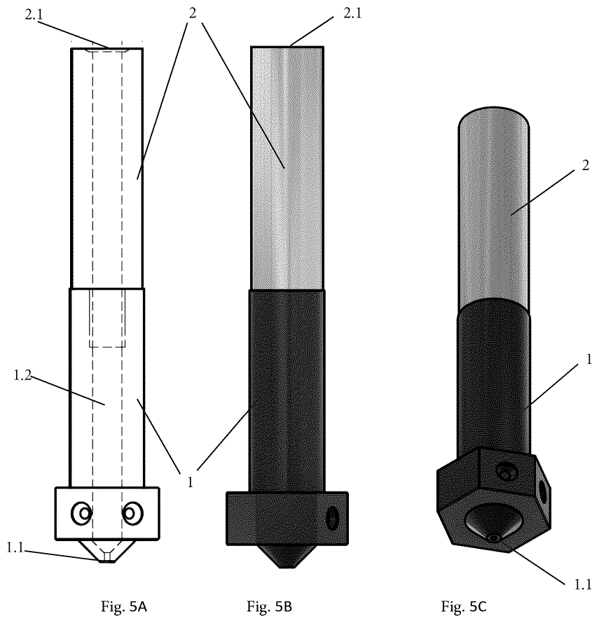

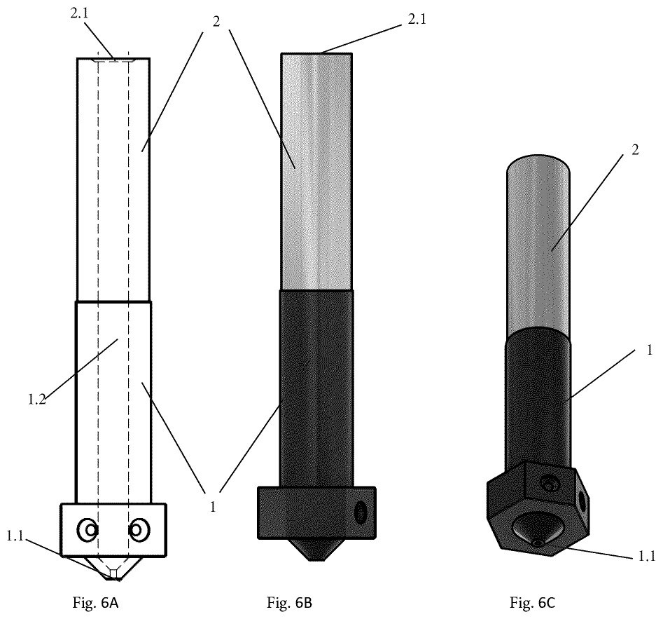

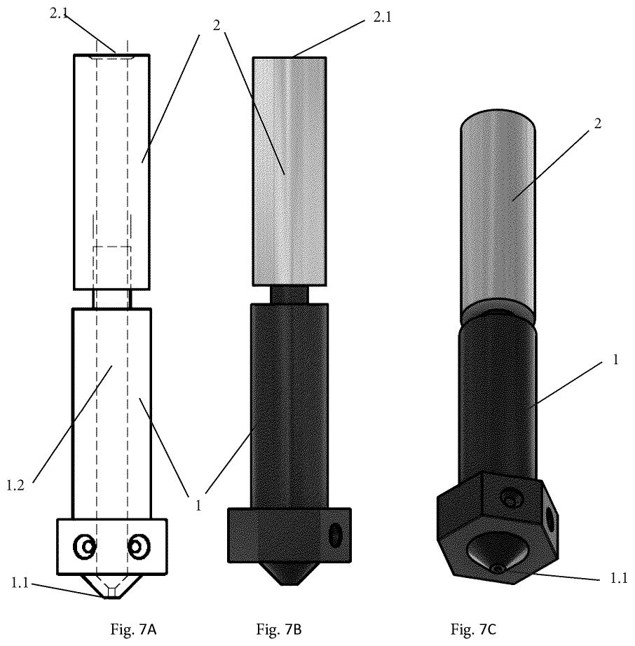

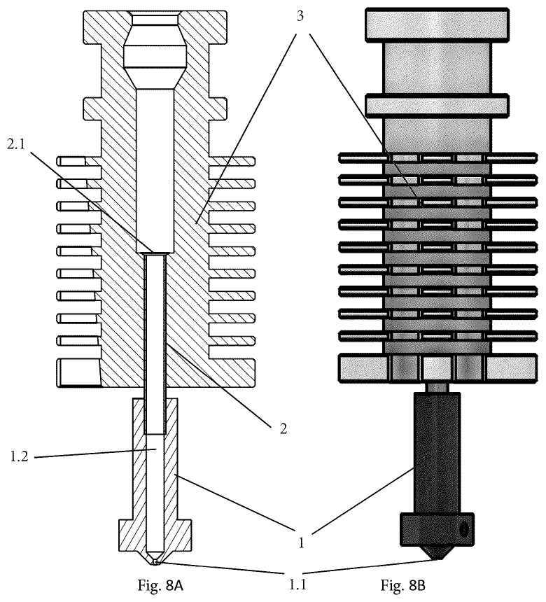

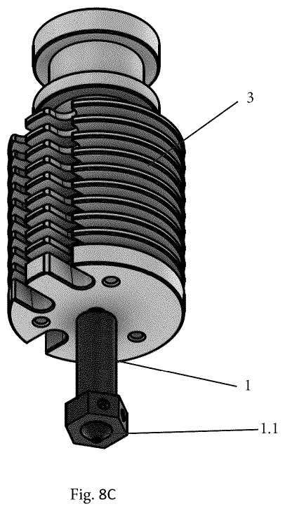

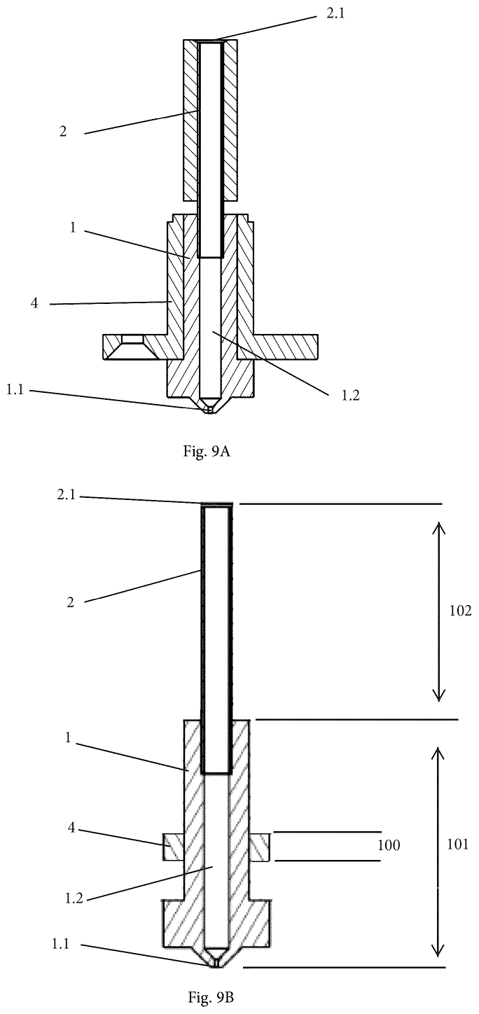

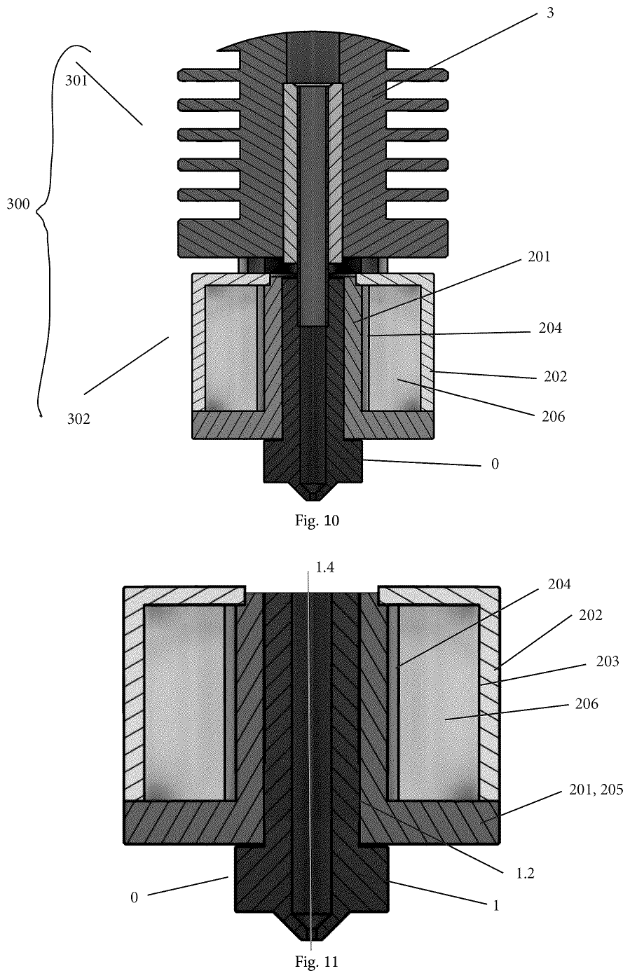

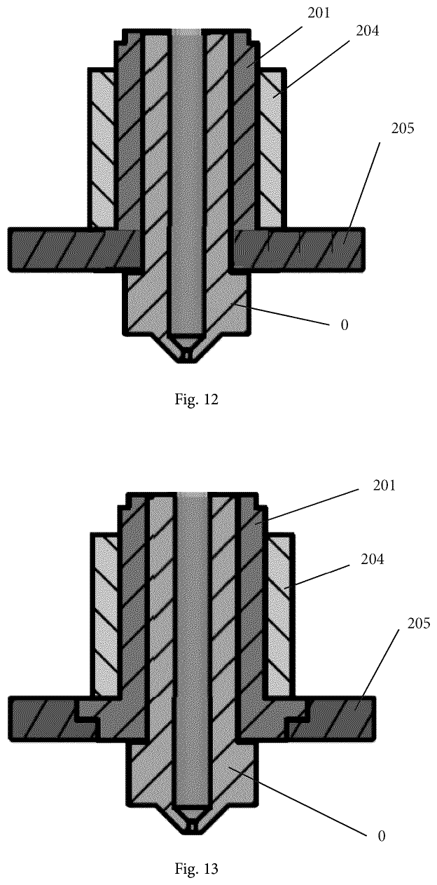

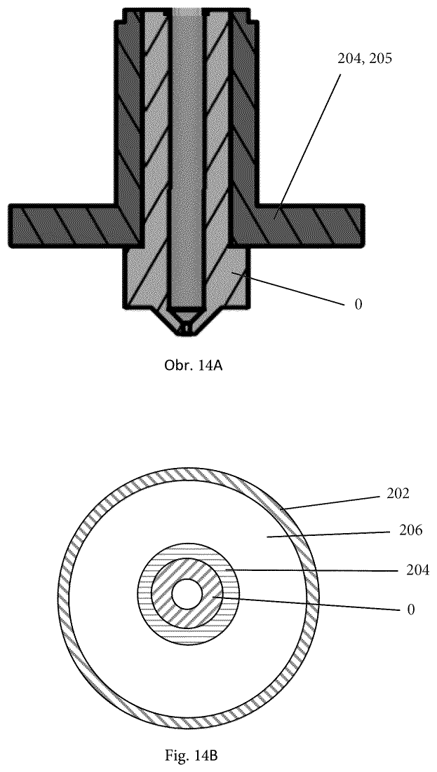

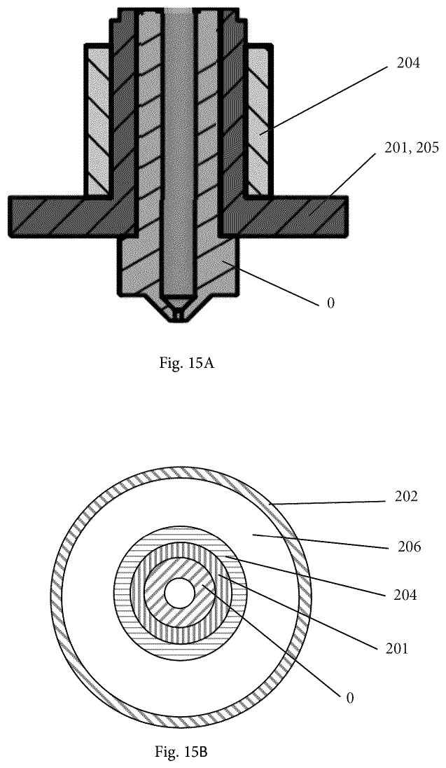

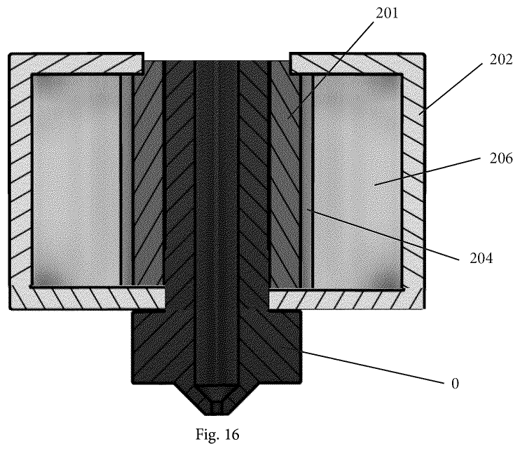

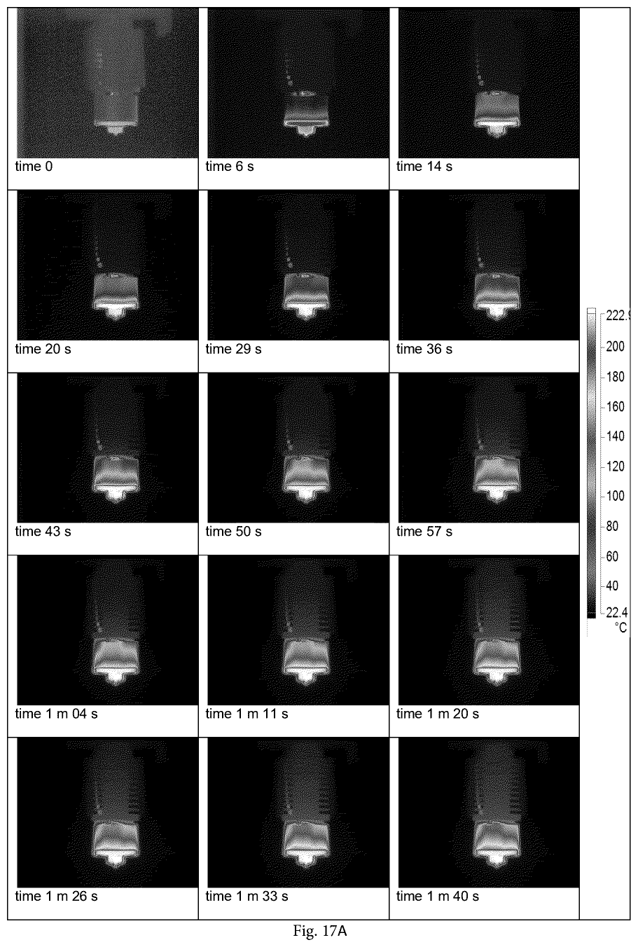

### EXAMPLES OF THE INVENTION EXECUTION

### Example 1 Melting System with a Cooled Opening for the Filament Inlet, the Feeder Inserted in the Nozzle and Pressed in

The body 1 of the cylindrical melting nozzle was turned out of copper and equipped with surface treatment based on nickel and diamond like carbon (DLC); its outer diameter was 5 mm, the diameter of the nozzle channel was 3 mm and the length was 13.5 mm; it was fitted with a hexagonal head with an outer diameter of 7 mm and a length of 3 mm. The nozzle channel 1.2 was terminated on the side of the head of the body 1 of the melting nozzle by the channel opening 1.1 with a diameter of 0.4 mm and on the other side, the nozzle channel 1.2 was fitted with the inserted feeder 2 of the filament made of stainless steel in the shape of a hollow cylinder with an outer diameter of 2.7 mm, an inner diameter of 1.9 mm, and a length of 10 mm, where it was inserted up to a depth of 5 mm into the nozzle channel 1.2 or the body 1 of the melting nozzle, respectively. Then the feeder 2 was pressed in the body 1 of the melting nozzle, thus making the connection between the feeder 2 of the filament and the body 1 of the melting nozzle sealed.

This body 1 of the melting nozzle with the pressed-in feeder 2 of the filament was fitted with the heating system 4 made of ceramics Al₂O₃ in the shape of a hollow cylinder with a length of 5 mm, an inner diameter of 5.5 mm, and an outer diameter of 8.5 mm, which was interwoven with a source of heat in the form of a resistance wire connected to the source of electric current. The opening 2.1 for the filament inlet situated at the end of the feeder 2 of the filament was offset from the body 1 of the melting nozzle by 5 mm and, considering the fact that the difference of the values of thermal conductivity coefficients of the body 1 of the melting nozzle and the feeder 2 exceeded 360 W/mK, the feeder 2 was able to decelerate heat transmission from the heating system 4 via the body 1 of the melting nozzle, thus cooling the opening 2.1 for the filament inlet in a passive manner. In addition, the feeder 2 of the filament was fitted on the cooler 3, offset from the body 1 of the melting nozzle 0 by 1 mm. The feeder 2 of the filament was thus implanted in the cooler 3 up to a depth of 4 mm.

### Example 2 Melting System with a Cooled Opening for the Filament Inlet, the Feeder Fits Close to the Nozzle, Manufactured by Smelting

The body 1 of the cylindrical melting nozzle 7 was manufactured together with the inserted feeder 2 of the filament by turning out from one piece, namely a gradient two-material solid piece. The piece was manufactured by pouring the alloy of bronze and aluminium into a cylindrical form, where each material was poured onto the opposite end of the mould and both materials met approximately in the middle of the mould and fused partially, by which a gradient of the materials was created. After cooling down, the solid piece was clamped in the lathe and machined. The body 1 of the melting nozzle was turned out on the aluminium side, had an outer diameter of 5 mm, the diameter of the nozzle channel 1.2 was 3 mm, and the length was 13.5 mm and it was equipped with the nozzle opening 1.1 with a diameter of 0.5 mm. The feeder 2 of the filament was turned out on the bronze side, had the outer diameter 2.7 mm, the inner diameter 1.9 mm, and the length 810 mm and fit close to the outlet of the nozzle channel 1.2 of the body 1 of the melting nozzle, thus extending the nozzle channel 1.2.

The body 1 of the melting nozzle manufactured together with the feeder 2 of the filament was fitted with the heating system 4 in the shape of a block with the dimensions 25×20×10 mm. The heating block was equipped with an opening for the body 1 of the melting nozzle with a diameter of 5.5 mm and an opening for the heating extruder core with a diameter of 4 mm; the heating extruder core with a diameter of 3.5 mm manufactured from some material with a high value of resistance, plated with an electrically non-conductive layer and connected to a source of electric current, was inserted into the heating block. The feeder 2 of the filament pressed-in in the body 1 of the melting nozzle with the fitted heating system 4 was equipped with the cooler 3 or was inserted the cooler 3, respectively, where the cooler 3 was offset from the body 1 of the melting nozzle 0 by 1 mm. The opening 2.1 for the filament inlet situated at the end of the feeder 2 of the filament was offset from the body 1 of the melting nozzle by 81 mm and the active cooling length, i.e. the length of the insertion of the feeder 2 of the filament in the cooler 3, was 80 mm. As the difference of the values of thermal conductivity coefficients of the body 1 of the melting nozzle and the feeder 2 exceeded 180 W/mK, the feeder 2 was able to decelerate heat transmission from the heating system 4 via the body 1 of the melting nozzle, thus cooling the opening 2.1 for the filament inlet in a passive manner. In addition, the opening 2.1 for the filament inlet was actively cooled by the cooler 3.

### Example 3 Melting System with a Cooled Opening for the Filament Inlet, the Feeder Fits Close to the Nozzle and Glued

The body 1 of the cylindrical melting nozzle 7 was manufactured from silicon carbide (SiC) and had the outer diameter 5 mm, the diameter of the nozzle channel 1.2 2 mm and the length 13.5 mm. The body 1 of the melting nozzle was equipped with the nozzle channel 1.1 with a diameter of 0.4 mm and with a sleeve flange on the other end. The sleeve flange referred to a hollow cylinder with a length of 3 mm, an inner diameter of 2 mm, and an outer diameter 3 mm and extended the nozzle channel 1.2. The sleeve flange was fitted from the outside with the feeder 2 of the filament manufactured from titanium in the shape of a hollow cylinder with the inner diameter 3.3 mm, the outer diameter 4.5 mm, and the length 20 mm. The connection between the feeder 2 of the filament and the body 1 of the melting nozzle or the sleeve flange, respectively of the body 1 of the melting nozzle was glued using some heat-resistant adhesive.

### Example 4 Melting System with a Cooled Opening for the Filament Inlet, the Feeder Fits Close to the Nozzle and Etched

The body 1 of the cylindrical melting nozzle 7 was manufactured from tungsten carbide (TC); its outer diameter was 5 mm, the diameter of the nozzle channel was 2 mm and the length was 15 mm; it was fitted with a hexagonal head with an outer diameter of 6 mm and a length of 4 mm. The nozzle channel 1.2 was terminated on the side of the head of the body 1 of the melting nozzle by the channel opening 1.1 with a diameter of 0.4 mm and on the other side, the nozzle channel 1.2 was fitted close and aligned based on the inner diameter with the feeder 2 of the filament made of PTFE plastic material in the shape of a hollow cylinder with an outer diameter of 3 mm, an inner diameter of 2 mm, and a length of 80 mm. The connection between the feeder 2 of the filament and the body 1 of the melting nozzle was glued-in by the plastic material etching.

### Example 5 Melting System with a Cooled Opening for the Filament Inlet, Soldered

The body 1 of the cylindrical melting nozzle 7 was manufactured from tungsten and had the outer diameter 5 mm, the diameter of the nozzle channel 2 mm and the length 20 mm. The nozzle channel 1.2 was terminated on the side of the head of the body 1 of the melting nozzle by the channel opening 1.1 with a diameter of 0.4 mm and on the other side, the nozzle channel 1.2 was fitted close and aligned based on the inner diameter with the feeder 2 of the filament made of brass in the shape of a hollow cylinder with an outer diameter of 5 mm, an inner diameter of 2 mm, and a length of 50 mm. The connection between the feeder 2 of the filament and the body 1 of the melting nozzle was soldered.

### Example 6 Melting System with a Cooled Opening for the Filament Inlet, Diamond

The body 1 of the cylindrical melting nozzle 7 was manufactured from diamond and had the outer diameter 5 mm, the diameter of the nozzle channel 1.2 was 2 mm and the length was 20 mm. The nozzle channel 1.2 was terminated on the side of the head of the body 1 of the melting nozzle by the channel opening 1.1 with a diameter of 0.4 mm and on the other side, the feeder 2 of the filament made of ceramics Al₂O₃ with an admixture of zirconium ZrO₂ in the shape of a hollow cylinder with an outer diameter of 1.7 mm, an inner diameter of 1.5 mm, and a length of 50 mm was inserted into the nozzle channel 1.2. The connection between the feeder 2 of the filament and the body 1 of the melting nozzle was glued using some heat-resistant adhesive.

### Example 7 Insulated Heating System of the Melting Nozzle, the Most Preferred Solution

The cylindrical melting nozzle 0 was turned out from copper, plated by nickel and DLC; its outer diameter was 5 mm, the diameter of the nozzle channel was 2 mm and the length was 13.5 mm; it was fitted with a hexagonal head with an outer diameter of 7 mm and a length of 3 mm. Some heat-conductive paste was applied to the cylindrical portion of the nozzle 0 which was then fitted with a component comprised of the assembly of a flat circular pad 205, with a thickness of 2.5 mm, an outer diameter of 20 mm with a centrally positioned opening with a diameter of 5.5 mm, and the heating insert 201 of the shape of a hollow cylinder with no bases having an outer diameter of 8 mm, an inner diameter of 5.5 mm, and a length of 11 mm, where the upper side of the heating insert 201 was equipped with a step/groove of a depth of 0.5 mm and a length of 1 mm. The bottom portion of the heating insert 201 fitted close to the pad 205, where the cylinder of the heating insert 201 and the pad 205 were manufactured from one piece of copper, meaning that they were non-dismountable. The pad 205 fitted on the melting nozzle 0 together with the heating insert 201 was stopped by the hexagonal head of the melting nozzle 0 and anchored in place in this way. The heating insert 201 fitted close directly to the casing 1.3 of the melting nozzle 0, by which their thermal contact was realized. Improved thermal contact, or more efficient heat transmission, respectively was enabled by thermally conductive paste applied between the heating insert 201 and the casing 1.3 of the melting nozzle 0. The thermally conductive paste was applied onto the outer casing of the heating insert 201 fitted on the body 1 of the melting nozzle 0 and the heating element 204, with the shape of a hollow cylinder with no bases and with an inner diameter of 8.5 mm, an outer diameter of 11 mm, and a length of 8 mm, was fitted. The heating element 204 fitted close directly to the heating insert 201, thus realizing their thermal contact. Improved thermal contact or more efficient heat transmission, respectively was enabled by thermally conductive paste applied between the heating insert 201 and the heating element 204.

The heating element 204 was manufactured from alumina, meaning oxide ceramics with the content of Al₂O₃. The source of heat for the heating element 204 was a resistance blade in the shape of a ring anchored in the heating element 204. The resistance blade was connected to a source of electric current.

Onto the body 1 of the melting nozzle 0 with the fitted heating insert 201 and with the fitted heating element 204, the insulation shell 202 having the shape of a hollow cylinder with the outer diameter 20 mm, the inner diameter 18 mm and the length 11 mm was fitted. The insulation shell 202 completely lacked one base and the other base of the insulation shell 202 had a thickness of 1 mm and was equipped with a central opening with a diameter of 6.5 mm. The edge of the opening allowed the insulation shell 202 to fit into the groove/recess of the heating insert 201.

The bottom edge of the insulation shell 202 fitted close to the pad 205. Between the outer casing of the heating element 204 and the inner casing 203 of the insulation shell 202, free space was created, the length of which perpendicularly to the axis 206 of the melting nozzle 0 was 3.5 mm. The free space/air pocket had the function of an insulation layer. The insulation shell 202 was manufactured from zirconium ceramics with the content of ZrO₂.

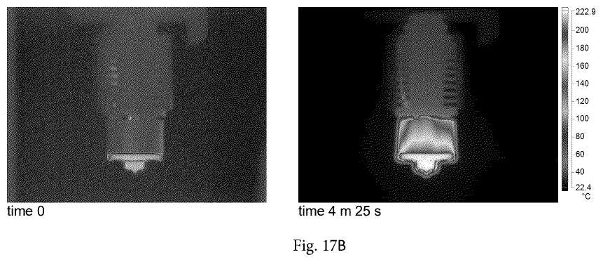

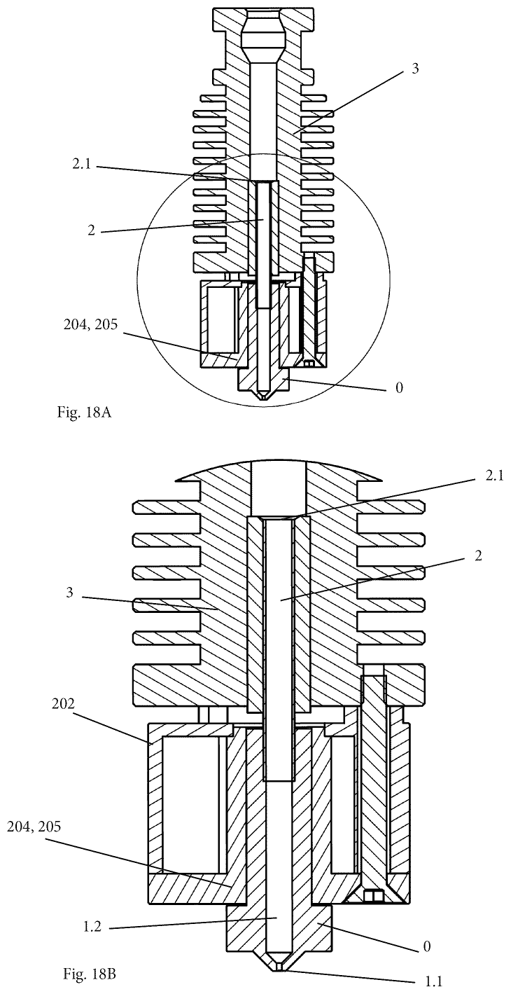

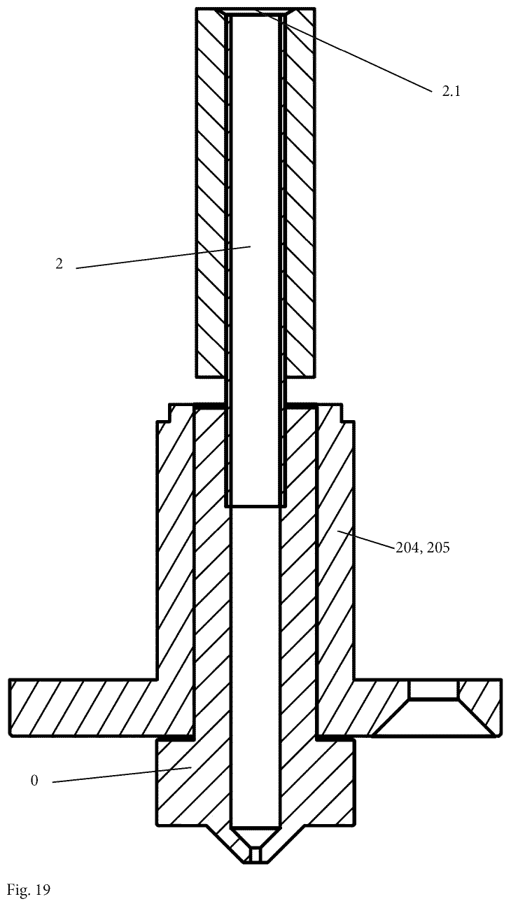

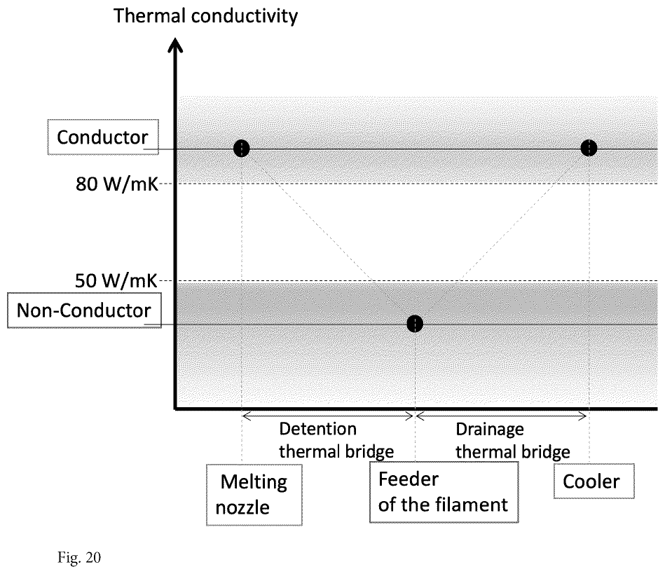

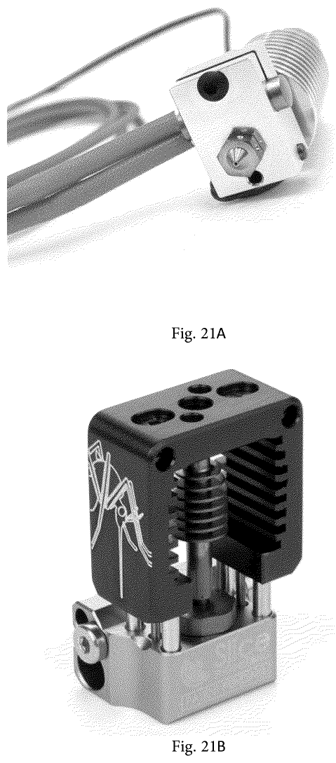

Thanks to the circular source of heat or the circular heating element 204, respectively homogeneous heating of the melting nozzle 0 within its entire cross section is possible, which results in more efficient and homogeneous melting of the print filament passing through the melting nozzle 0. Thanks to the presence of the heating insert 201, heat is distributed effectively and the melting nozzle 0 is heated not only at the level of the heating element 204, but also along the entire level of the heating insert 201. In addition, the heating system is efficiently insulated both by the air pocket, and the insulation shell 202, by which thermal losses are minimized and heat is effectively used for heating up the melting nozzle 0; in addition, the outer temperature of the insulation shell 202 is lower than 50° C., as it can be seen in FIG. 17, meaning that it is possible to handle the print head 300 during a print job as well as immediately thereafter, where the print heads according to the state of the art report outer contact temperature exceeding 100° C.

The system was tested by inserting into the print head and putting it into operation. During operation, the print head was sensed by a heat-detecting thermal camera. Pictures from the thermal camera are provided in FIG. 17. It can be seen that even after 1 m 40 s the insulation shell 202 has a temperature ranging between 40 and 50° C. and the temperature remains constant during 4 m 25 s of operation.

### Example 8 Insulated Heating System of the Melting Nozzle, with No Insert, a Ring Fitted Directly on the Nozzle, Pad Separately

The melting nozzle 0 manufactured from carbide SiC with an outer diameter of 5 mm, a diameter of the channel of 2 mm, and a length of 13.5 mm with a hexagonal head having an outer diameter of 7 mm and a length of 3 mm was fitted with the ceramic pad 205 with a thickness of 2.5 mm, an outer diameter of 20 mm with a centrally situated opening with a diameter of 5.5 mm manufactured from titanium. The pad 205 fitted on the melting nozzle 0 was stopped by the hexagonal head of the melting nozzle 0 and anchored in place in this way. The melting nozzle 0 was then fitted with the heating element 204 that had the shape of a hollow cylinder with an inner diameter of 5.5 mm, an outer diameter of 8 mm, and a length of 8 mm. The heating element 204 thus fitted close directly to the casing 1.3 of the melting nozzle 0, by which their thermal contact was allowed. The bottom edge of the cylinder of the heating element 204 fitted close to the pad 205, where the cylinder of the heating element 204 was manufactured from alumina, meaning oxide ceramics with the content of Al₂O₃. The source of heat for the heating element 204 was a collar made of a resistance wire anchored in the heating element 204.

Onto the body 1 of the melting nozzle 0 with the fitted heating element 204, the insulation shell 202 having the shape of a hollow cylinder with the outer diameter 20 mm, the inner diameter 18 mm, and the length 11 mm was fitted. The insulation shell 202 completely lacked one base and the other base of the insulation shell 202 had a thickness of 1 mm and was equipped with a central opening with a diameter of 5.5 mm. The edge of the opening of the insulation shell 202 fitted close to the casing 1.3 of the melting nozzle 0. The bottom edge of the insulation shell 202 fitted close to the pad 205. Between the outer casing of the heating element 204 and the inner casing 203 of the insulation shell 202, free space was created, the length of which perpendicularly to the axis 1.4 of the melting nozzle 0 was 5 mm. The free space/air pocket had the function of an insulation layer. The insulation shell 202 was manufactured from stainless steel.

Thanks to the circular source of heat or the circular heating element 204, respectively homogeneous heating of the melting nozzle 0 within its entire cross section is possible, which results in more efficient and homogeneous melting of the print filament passing through the melting nozzle 0. In addition, the heating system is efficiently insulated both by the air pocket, and the insulation shell 202, by which thermal losses are minimized and heat is effectively used for heating up the melting nozzle 0; in addition, the outer temperature of the insulation shell 202 is lower than 70° C., meaning that it is possible to handle the print head 300 during a print job as well as immediately thereafter, where the print heads according to the state of the art report the outer contact temperature exceeding 100° C.

### Example 9 Insulated Heating System of the Melting Nozzle, Pad with Openings, Insulation Shell Opened at the Top and at the Bottom as Well

Onto the cylindrical melting nozzle 0 manufactured from carbide TC with the outer diameter 5 mm, the diameter of the channel 2 mm and the length 15 mm, the ceramic pad 205 with a thickness of 1 mm, an outer diameter of 20 mm with a centrally situated opening with a diameter of 5.5 mm and with six more symmetrically located circular openings with a diameter of 4 mm manufactured from the PTFE plastic material was fitted. The pad 205 was glued onto the melting nozzle 0 using some thermally conductive adhesive at a distance of 12 mm from the upper edge of the melting nozzle 0, by which it was anchored in place. The melting nozzle 0 was then fitted with the heating element 204 that had the shape of a collar with an inner diameter of 5.5 mm, an outer diameter of 8.5 mm, and a length of 1.5 mm. The heating element 204 thus fitted close directly to the casing 1.3 of the melting nozzle 0, by which their thermal contact was allowed. The bottom edge of the collar of the heating element 204 fitted close to the pad 205, where the cylinder of the heating element 204 was manufactured from alumina, meaning oxide ceramics with the content of Al₂O₃. The source of heat for the heating element 204 was a collar made of a resistance wire anchored in the heating element 204.

Onto the body 1 of the melting nozzle 0 with the fitted heating element 204, the insulation shell 202 having the shape of a hollow cylinder with the outer diameter 20 mm, the inner diameter 18 mm, and the length 12 mm was fitted. The insulation shell 202 completely lacked both its bases. The bottom edge of the insulation shell 202 fitted close to the pad 205. Between the outer casing of the heating element 204 and the inner casing 203 of the insulation shell 202, free space was created, the length of which perpendicularly to the axis 1.4 of the melting nozzle 0 was 5 mm. The free space/air pocket had the function of an insulation layer. The insulation shell 202 was manufactured from glass.

Thanks to the circular source of heat or the circular heating element 204, respectively homogeneous heating of the melting nozzle 0 within its entire cross section is possible, which results in more efficient and homogeneous melting of the print filament passing through the melting nozzle 0. In addition, the heating system is efficiently insulated both by the air pocket, and the insulation shell 202, by which thermal losses are minimized and heat is effectively used for heating up the melting nozzle 0; in addition, the outer temperature of the insulation shell 202 is lower than 60° C., meaning that it is possible to handle the print head 300 during a print job as well as immediately thereafter, where the print heads according to the state of the art report the outer contact temperature exceeding 100° C.

### Example 10 Insulated Heating System of the Melting Nozzle, No Pad, with Insert, the Shell in the Shape of a Prism

The cylindrical melting nozzle 0 manufactured from carbide SiC with the outer diameter 5 mm, the diameter of the channel 2 mm, and the length 15 mm was fitted with the heating insert 201 made of copper, in the shape of a hollow cylinder with an outer diameter of 8 mm, an inner diameter of 5.5 mm, and a length of 11 mm. The heating insert 201 fitted close directly to the casing 1.3 of the melting nozzle 0, by which their thermal contact was allowed.

Some thermally conductive paste was applied onto the outer casing of the heating insert 201 fitted on the body 1 of the melting nozzle 0 and the heating element 204, with the shape of a hollow cylinder with no bases and having an inner diameter of 8.5 mm, an outer diameter of 11 mm, and a length of 5 mm, was fitted. The heating element 204 fitted close directly to the heating insert 201, thus allowing their thermal contact. Improved thermal contact or more efficient heat transmission, respectively was enabled by thermally conductive paste applied between the heating insert 201 and the heating element 204. The source of heat for the heating element 204 was a collar made of a resistance wire anchored in the heating element 204.

Onto the body 1 of the melting nozzle 0 with the fitted heating insert 201 and with the fitted heating element 204, the insulation shell 202 having the shape of a hollow 6-sided prism with the outer diameter 20 mm, the thickness of the wall 1 mm and the length 12 mm was fitted. The insulation shell 202 completely lacked one base and the other base was equipped with a central opening with a diameter of 5.5 mm. The edge of the opening of the insulation shell 202 fitted close to the casing 1.3 of the melting nozzle 0, to which it was glued using some heat-resistant adhesive at a distance of 1 mm from the upper edge of the melting nozzle 0. Between the outer casing 204.1 of the heating element 204 and the inner casing 203 of the insulation shell 22, free space was created opened to the surrounding environment thanks to the absence of the pad 205. The free space/air pocket had the function of insulation material and partly a cooling layer. The insulation shell 202 was manufactured from ceramics with the content of ZrO₂.

Thanks to the circular source of heat or the circular heating element 204, respectively homogeneous heating of the melting nozzle 0 within its entire cross section is possible, which results in more efficient and homogeneous melting of the print filament passing through the melting nozzle 0. Thanks to the presence of the heating insert 201, heat is distributed effectively and the melting nozzle 0 is heated not only at the level of the heating element 204, but also along the entire level of the heating insert 201. In addition, the heating system is efficiently insulated both by the air pocket, and the insulation shell 202, by which thermal losses are minimized and heat is effectively used for heating up the melting nozzle 0; in addition, the outer temperature of the insulation shell 202 is lower than 50° C., meaning that it is possible to handle the print head 300 during a print job as well as immediately thereafter, where the print heads according to the state of the art report the outer contact temperature exceeding 100° C.

### LIST OF MARKS FOR TERMS

0. Melting nozzle
1. Body of the melting nozzle
   1.1 Nozzle opening of the melting nozzle
   1.2 Nozzle channel of the melting nozzle
   1.3 Casing of the melting nozzle
   1.4 Longitudinal axis of the melting nozzle
2. Feeder of the filament
   2.1 Opening for the filament inlet
3. Cooler
4. Heating system
100. Melting zone
101. Heating zone
102. Cooled zone
201 Heating insert
202 Insulation shell
203 Inner casing of the hollow insulation body
204 Heating element
   204.1 Outer casing of the heating element
205 Pad
206 Free insulation space
300 Print head
301 Cooling portion of the print head 100, “coldpart”
302 Heated portion of the print head 100, “hotpart”

### INDUSTRIAL APPLICABILITY

Improvement of 3D print precision, elimination of escaping from below, more efficient melting of printing material

1. A vertically insulated, homogeneously heated melting system with a cooled opening (2.1) for a filament inlet for 3D printers, characterized in that it comprises a melting zone (100), heated zone (101), and cooled zone (102), where the heated zone (101) is mechanically connected with the cooled zone (102) and thermally insulated by a heat conductor-heat non-conductor-heat conductor (CNC) system, where the one heat conductor of the CNC system, being a melting nozzle (0), is situated inside the heated zone (101) and the other heat conductor of the CNC system, being a cooler (3), is situated in the cooled zone (102), where both heat conductors are mechanically connected by the heat non-conductor, being a feeder (2) of the filament, which is also thermally connected to both the melting nozzle (0), and the cooler (3); the melting zone (100) is equipped with a heating element (204) connected to a source of heat, where the source of heat is comprised of a hollow body comprising a cavity with a circular cross-section that is fitted onto a body (1) of the melting nozzle (0) and is thermally connected to the body (1) of the melting nozzle (0), where the melting nozzle (0) is equipped with a nozzle channel (1.2) for a passage of the filament having a shape of a hollow body with a circular cross-section and with a constant or continuously variable diameter, where the nozzle channel (1.2) is led by the feeder (2) of the filament outside the body (1) of the melting nozzle (0) and terminated by the opening (2.1) for the filament inlet, situated in the cooler (3), meaning in the cooled zone (102), the feeder (2) of the filament and the body (1) of the melting nozzle (0) are connected by a non-dismountable connection or are manufactured from one piece, the feeder (2) of the filament is implanted in the cooler (3) up to a depth of at least 4 mm, and the cooler (3) is offset from the melting nozzle (0) by at least 1 mm, and a value of thermal transmittance of the feeder (2) of the filament is at least 3 times lower than a value of thermal transmittance of the body (1) of the melting nozzle (0) and the value of thermal transmittance of the feeder (2) of the filament is at least 3 times lower than a value of thermal transmittance of the cooler (3).

2. The vertically insulated, homogeneously heated melting system with a cooled opening (2.1) for the filament inlet for 3D printers according to claim 1, characterized in that the feeder (2) of the filament is implanted in the cooler (3) up to a depth ranging from 20 to 80 mm.

3. The vertically insulated, homogeneously heated melting system with a cooled opening (2.1) for the filament inlet for 3D printers according to claim 1, characterized in that the heating system (4) fitted on the body (1) of the melting nozzle comprises a resistant wire connected to a source of electric current.

4. The vertically insulated, homogeneously heated melting system with a cooled opening (2.1) for the filament inlet for 3D printers according to claim 1, characterized in that the heat conductors, being the body (1) of the melting nozzle (0) and the cooler (3), are manufactured from some material whose value of thermal conductivity is at least 30 W/mK.

5. The vertically insulated, homogeneously heated melting system with a cooled opening (2.1) for the filament inlet for 3D printers according to claim 4, characterized in that the heat conductors, being the body (1) of the melting nozzle (0) and the cooler (3), are manufactured from copper, aluminium, bronze, brass, iron, steel, silver, gold, diamond, tungsten, tungsten carbide (TC), silicon carbide (SiC, SiSiC), aluminium oxide (Al₂O₃) or a mixture thereof.

6. The vertically insulated, homogeneously heated melting system with a cooled opening (2.1) for the filament inlet for 3D printers according to claim 1, characterized in that the heat non-conductor, being the feeder (2) of the filament, is manufactured from copper, aluminium, bronze, brass, iron, steel, silver, gold, diamond, tungsten, tungsten carbide (TC), silicon carbide (SiC, SiSiC), aluminium oxide (Al₂O₃), magnesium oxide (MgO), ytterbium oxide (Y₂O₃), zirconium dioxide (ZrO₂), machinable vitroceramics, stealite, ceramics, polytetrafluorethylene (PTFE), polyaryletherketone (PAEK), polyether ether ketone (PEEK), polyetherimide (PEI) or a mixture thereof.

7. The vertically insulated, homogeneously heated melting system with a cooled opening (2.1) for the filament inlet for 3D printers according to claim 1, characterized in that the heat non-conductor, being the feeder (2) of the filament, has the value of thermal conductivity coefficient at least by 30 W/mK lower than the values of the conductors, being the body (1) of the melting nozzle and the cooler (3).

8. The vertically insulated, homogeneously heated melting system with a cooled opening (2.1) for the filament inlet for 3D printers according to claim 1, characterized in that the body (1) of the melting nozzle (0) and the cooler (3) are manufactured from some material whose thermal conductivity is at least 80 W/mK, and the non-conductor, being the feeder (2) of the filament, is manufactured from some material whose thermal conductivity does not exceed 50 W/mK.

9. The vertically insulated, homogeneously heated melting system with a cooled opening (2.1) for the filament inlet for 3D printers according to claim 1, characterized in that the feeder (2) of the filament has the thickness of the wall at least 3 times lower than the body (1) of the melting nozzle (0).

10. The vertically insulated, homogeneously heated melting system with a cooled opening (2.1) for the filament inlet for 3D printers according to claim 1, characterized in that the non-dismountable connection between the feeder (2) of the filament and the body (1) of the melting nozzle (0) is created by brazing, soldering, gluing, pressing or etching.

11. The vertically insulated, homogeneously heated melting system with a cooled opening (2.1) for the filament inlet for 3D printers according to claim 1, characterized in that the feeder (2) of the filament and the body (1) of the melting nozzle (0) are turned out from one piece of material.

12. The vertically insulated, homogeneously heated melting system with a cooled opening (2.1) for the filament inlet for 3D printers according to claim 11, characterized in that the feeder (2) of the filament and the body (1) of the melting nozzle (0) are turned out from one solid piece manufactured from two materials with a material gradient between them.

13. The vertically insulated, homogeneously heated melting system with a cooled opening (2.1) for the filament inlet for 3D printers according to claim 1, characterized in that the body (1) of the melting nozzle (0) is fitted with a sleeve flange in the place of the nozzle channel (1.2) outlet at the end opposite to the nozzle opening (1.1), onto which the feeder (2) of the filament is fitted.

14. The vertically insulated, homogeneously heated melting system with a cooled opening (2.1) for the filament inlet for 3D printers according to claim 1, characterized in that the feeder (2) of the filament fits close to the body (1) of the melting nozzle (0) in the place of the nozzle channel (1.2) outlet at the end opposite to the nozzle opening (1.1), or it is inserted into the nozzle channel (1.2).

15. The vertically insulated, homogeneously heated melting system with a cooled opening (2.1) for the filament inlet for 3D printers according to claim 1, characterized in that the feeder (2) of the filament is equipped with an outer thread.

16. The vertically insulated, homogeneously heated melting system with a cooled opening (2.1) for the filament inlet for 3D printers according to claim 15, characterized in that the outer thread on the feeder (2) of the filament corresponds to the inner thread of the cooler (3).

17. A horizontally insulated, homogeneously heated melting system for gripping the nozzle for 3D printers, characterized in that it comprises a melting nozzle (0), a heating element (204) connected to a source of heat formed by a hollow body with a cavity having a circular cross-section that is fitted onto a body (1) of the melting nozzle (0) and is thermally connected to the body (1) of the melting nozzle (0) by fitting onto, and the heating element (204) is fitted with an insulation shell (202), where the melting nozzle (0) has a shape of a cylinder with a through channel, where between an outer casingcasing (204.1) of the heating element (204) and the inner casing casing(203) of the insulation shell (202), perpendicularly to an axis (1.4) of the melting nozzle (0), is free insulation space (206).

18. The horizontally insulated, homogeneously heated melting system for 3D printers according to claim 17, characterized in that the heating element (204) has the value of thermal conductivity coefficient at least 20 W/mK.

19. The horizontally insulated, homogeneously heated melting system for 3D printers according to claim 17, characterized in that the free insulation space (206) has the length perpendicularly to the axis (1.4) of the melting nozzle (0) at least 1 mm.

20. The horizontally insulated, homogeneously heated melting system for 3D printers according to claim 17, characterized in that the insulation shell (202) has the shape of a hollow cylinder, a hollow n-sided prism, a hollow block, a hollow cube or a hollow polyhedron, where the two opposite bases thereof are equipped with a central opening whose diameter is greater than a smallest outer diameter of the melting nozzle (0), or the insulation shell (202) has a shape where a diameter of the opening is greater than the smallest outer diameter of the melting nozzle (0).

21. The horizontally insulated, homogeneously heated melting system for 3D printers according to claim 17, characterized in that between the heating element (204) and the outer casingcasing (1.3) of the melting nozzle (0) is a heating insert (201), wherein the heating insert (201) comprised of at least a hollow cylinder that is in thermal contact with both the outer casingcasing (1.3) of the melting nozzle (0) and the heating element (204) is inserted.

22. The horizontally insulated, homogeneously heated melting system for 3D printers according to claim 17, characterized in that the heating element (204) is manufactured from the thermally conductive ceramics with the content of Al₂O₃, SiC, SiO₂, TC or a mixture thereof.

23. The horizontally insulated, homogeneously heated melting system for 3D printers according to claim 20, characterized in that the heating insert (201) is manufactured from some material with the value of thermal conductivity at least 20 W/mK.

24. The horizontally insulated, homogeneously heated melting system for 3D printers according to claim 22, characterized in that the heating insert (201) is manufactured from aluminium, copper, bronze, brass, silver, gold, carbide, ceramics or a mixture thereof.

25. The horizontally insulated, homogeneously heated melting system for 3D printers according to claim 17 or 20, characterized in that some thermally conductive paste is applied between the heating element (204) and the body (1) of the melting nozzle (0), and/or between the heating element (204) and the heating insert (201), and/or between the heating insert (201) and the body (1) of the melting nozzle (0).

26. The horizontally insulated, homogeneously heated melting system for 3D printers according to claim 17, characterized in that the insulation shell (202) is manufactured from some material with the value of thermal conductivity not exceeding 50 W/mK.

27. The horizontally insulated, homogeneously heated melting system for 3D printers according to claim 17, characterized in that the insulation shell (202) is manufactured from ceramics, preferably zirconium ceramics, aluminium ceramics (Al₂O₃), stainless steel, titanium, glass, zirconium dioxide (ZrO₂), machinable vitroceramics, stealite, ceramics, polytetrafluorethylene (PTFE), polyaryletherketone (PAEK), polyether ether ketone (PEEK), polyetherimide (PEI) or a mixture thereof.

28. The horizontally insulated, homogeneously heated melting system for 3D printers according to claim 17, characterized in that the melting nozzle (0) is equipped with the head whose diameter is greater than the diameter of the cylindrical portion of the melting nozzle (0).

29. The horizontally insulated, homogeneously heated melting system for 3D printers according to claim 17, characterized in that the bottom edge of the heating element (204) fits close to a flat circular pad (205) with a central opening a diameter of which is greater than a smallest outer diameter of the melting nozzle (0) and at the same time smaller than a greatest diameter of the melting nozzle (0).

30. The horizontally insulated, homogeneously heated melting system for 3D printers according to claim 29, characterized in that the heating element (204) and the pad (205) are manufactured from one piece.

31. The horizontally insulated, homogeneously heated melting system for 3D printers according to claim 20, characterized in that the bottom edge of the heating insert (201) fits close to a flat circular pad (205) with a central opening whose diameter is greater than a smallest outer diameter of the melting nozzle (0) and at the same time smaller than a greatest diameter of the melting nozzle (0).

32. The horizontally insulated, homogeneously heated melting system for 3D printers according to claim 31, characterized in that the heating insert (201) and the pad (205) are manufactured from one piece.

33. The horizontally insulated, homogeneously heated melting system for 3D printers according to claim 17, characterized in that the bottom edge of the insulation shell (202) fits close to the flat circular pad (205) with a central opening whose diameter is greater than the smallest outer diameter of the melting nozzle (0) and at the same time smaller than a greatest diameter of the melting nozzle (0).

34. The horizontally insulated, homogeneously heated melting system for 3D printers according to claim 33, characterized in that the insulation shell (202) and the pad (205) are manufactured from one piece.
